(19) United States
(12) Patent Application Publication
(10) Pub. No.: US 2018/0204284 A1
(43) Pub. Date: Jul. 19, 2018

(54) CRYPTOGRAPHICALLY SECURE FINANCIAL INSTRUMENTS

(71) Applicant: David Cerezo Sanchez, Madrid (ES)

(72) Inventor: David Cerezo Sanchez, Madrid (ES)

(21) Appl. No.: 15/743,647

(22) PCT Filed: Jul. 30, 2015
(86) PCT No.: PCT/IB2015/055776

§ 371 Date: Jan. 10, 2018

(51) Int. Cl. G06Q 40/06

(52) U.S. Cl. CPC G06Q 40/06; H04L 9/008

(57) ABSTRACT

Systems, methods and financial instruments enhanced with secure computation. A financial instrument management system is implemented with secure computation capabilities, respecting the privacy and secrecy rights during computation of the information contained within financial instruments, external datasets and/or secure computation programs. Automatic conversion and aggregation of conventional financial instruments is also disclosed. Furthermore, secure computation programs can be certified with mathematical proofs about very advantageous and valuable properties such as their correct termination, conformance to a specification, or any other pre-conditions, post-conditions and invariants on their inputs and outputs, encrypted or in plaintext form.

### TECHNICAL FIELD

This invention relates to financial instruments and more particularly to systems and methods to provide financial instruments enhanced with secure computation.

### BACKGROUND ART

The trading of numerous financial instruments give rise to financial markets, said financial instruments featuring an indefinite amount of terms. A common feature to any of them is the importance of some common terms for their definition: dates, prices, involved parties, current valuation and other parameters. Customarily, said data has always been publicly shared: terms of the contracts between the participating parties have to been known between them, and ultimately to the markets if said financial instruments are publicly traded. Even taking into consideration that one party is perfectly able to use his own private sources of information to trade and value financial instruments, the restriction to mostly rely on publicly accessible information creates deep market imperfections: that is, the lack of publicly accessible sources of commercial and secret information obstructs the correction of market imperfections, increasing valuations and risks.

Advantageously, the latest advances in cryptography enabling the computation with data and computer code in a secure way, without any of the parties learning anything but the result of the computation, can be used within the field of finance to improve the availability, quality and quantity of the information used to price and trade financial instruments: exemplarily, secret datasets of information collected by third-parties could be used to price financial instruments; better estimations of financial risk could be calculated using said secrets datasets, ultimately reducing risk; secret functions provided by third-parties could be used to value financial instruments and indices, without disclosing said secret functions; and guarantees could be provided in the form of mathematical proofs that secure computation programs conform to specifications and/or restrictions, a feature of great importance specially when secure computation programs are in encrypted form and the financial instruments are given to third parties that may not trust it.

It is therefore an object of the present disclosure to provide financial instruments enhanced with secure computation.

### SUMMARY OF INVENTION

The object is solved by a financial instrument, a computer implemented method and a financial instrument management system to carry out secure computation on financial instruments according to the present claims.

The basic idea of the present disclosure is to enhance financial instruments with secure computation, in their multiple forms: on an original, unmodified financial instrument; on a converted financial instrument from an unmodified financial instrument, said conversion encrypting some of the values of its fields; on an aggregate financial instrument created from unmodified and modified financial instruments; on a modified financial instrument including a proof-certified secure computation program; and on a modified financial instrument including a proof-certified encrypted secure computation program. All these innovative variations on financial instruments are provided by a financial instrument management system in which a secure processing module obtains, keeps and checks the correctness of financial instruments and a secure cryptographic module that encrypts and decrypts terms and/or values of financial instruments and executes one or more secure computation programs on said financial instruments using at least one privacy-preserving protocol. Financial instruments are the perfect field in which to apply secure computation techniques due to the reason that the number of terms and/or values that define them is very small in relation to their high economic value, justifying the much higher costs of computing with secure computation techniques; that is, apart from the traditional demands from finance of secrecy and privacy. This basic idea can be further extended: proof-certified secure computation programs also provide guarantees in the form of mathematical proofs over said secure computation programs, regarding their termination, conformance to specifications and in general their well-behaviour; this feature is of paramount importance in assuring trust to third parties whenever financial instruments are transferred to them, especially when said secure computation programs are in encrypted form and they have to blindly execute them.

In the interest of clarity, several terms which follow are specifically defined for use herein. The term “financial instrument” is used herein to refer to any contract that gives rise to a financial asset of one entity and a financial liability or equity instrument of another entity. Examples of financial instruments are as follows, but not limited to this list: bonds, loans, futures, options, swaps, caps, floors, forwards, commercial papers, bills, deposits, stock and derivatives, among others.

The term “secure computation program” is used herein to refer to any program that comprises executable code and encrypted information using modern cryptographic techniques to securely compute on data and computer code. The terms ‘secure computation program’ and ‘secure program’ can be used interchangeably herein.

The term “proof-certified secure computation program” is used herein to refer to any secure computation program accompanied with at least one mathematical proof. Said proof could be about any property of the secure computation program, such as correct termination; conformance of the secure computation program to a specification; and proofs assuring that some pre-conditions, post-conditions and invariants will be maintained; among other purposes of said proofs.

The term “encrypted secure computation program” is used herein to refer to any secure computation program whose code is encrypted in a cryptographically secure way.

The term “privacy-preserving protocol” is used herein to refer to any cryptographic protocol and/or technique that allows computation on encrypted data, comprising: garbled circuits and oblivious transfers, GMW circuits, secret sharing, homomorphic encryption, oblivious random access machines (ORAMs), and combinations thereof. It can also be used interchangeably to refer to any cryptographic protocol and/or technique that allows computation with encrypted code, comprising: reusable garbled circuits, circuits over secret sharing schemes, circuits over homomorphic encryption schemes, cryptographically-secure obfuscation, and combinations thereof.

The term “terms and/or values of financial instruments” is used herein to refer to any property, explicit or implicit, of a financial instrument such as dates, numerical values such as prices and non-numerical ones, involved parties, trading venue, type of instrument, method of calculation and, in general, any other parameter of said financial instrument.

The term “fields of financial instruments” is used herein to refer to any named reference, explicit or implicit, to the terms and/or values of a financial instrument. The terms ‘fields’ and ‘tags’ can be used interchangeably herein.

The term “and/or” is used herein to mean both “and” as well as “or”. For example, “A and/or B” is construed to mean A, B or A and B.

By ‘module’ as a term is used herein, it may include hardware and/or software.

According to the present disclosure, a financial instrument having at least a value determined by the result of at least a secure computation program executed on at least one computer device. According to this embodiment, the main advantage is that the secure computation techniques described in the present disclosure can be applied to any financial instrument, with no modifications.

According to another embodiment, said financial instrument is converted from a financial instrument with no value determined by the result of at least a secure computation program executed on at least one computer device to a financial instrument with at least one encrypted term or value. The main benefit of this embodiment is that conventional financial instruments are transformed and updated to be used with the disclosed management system for financial instruments.

According to a further embodiment, said financial instrument is aggregated from financial instruments with no value determined by the result of at least a secure computation program executed on at least one computer device; and/or financial instruments with at least one encrypted term and/or value. The main benefit of this embodiment is that an aggregate financial instrument can be created, respecting the secrecy and privacy of data contained on the financial instruments that are being aggregated: said aggregate financial instruments would be of great utility to devise new ways to package financial instruments.

According to a further embodiment, said financial instrument contains a proof-certified secure computation program. The main advantage of this embodiment is that secure computation programs reside within the financial instruments, so they can be transferred and executed by third parties. Another advantage is that said secure computation programs are accompanied by mathematical proofs of any property that can be possibly proved about them, improving the safety and trustworthiness of said financial instruments when transferred to third parties.

According to a further preferred embodiment, said financial instrument contains an encrypted proof-certified secure computation program. The main advantage of this embodiment is that secure computation programs support the most modern cryptographic techniques regarding encrypted computation, so the executing party of said secure computation program could not learn anything substantial about it; however, the mathematical proofs accompanying said encrypted secure computation program certify its well-behaviour.

According to a further embodiment, a computer implemented method for securely computing one or more financial instruments, the method comprising at least one or more of: encrypting and/or decrypting terms and/or values of said financial instruments; and executing one or more secure computation programs on said financial instruments using at least one privacy-preserving protocol from a group of privacy-preserving protocols consisting of: garbled circuits and oblivious transfers, GMW circuits, secret sharing, homomorphic encryption, oblivious random access machines (ORAMs), and combinations thereof; garbled circuits and oblivious transfer being the preferred one. According to this embodiment, one of its main advantages is the variety of supported cryptographic techniques, combining different security models with the shortcomings of some cryptographic techniques resolved by the benefits of others. Details of the protocols and cryptographic techniques can be found in the papers cited herein and in the following books [Manoj M. Prabhakaran; Amit Sahai. ‘Secure Multi-Party Computation’. IOS Press, 2013. ISBN 978-1-61499-168-7; Thomas Schneider. ‘Engineering Secure Two-Party Computation Protocols’. Springer, 2012. ISBN 978-3-642-30041-7; Carmit Hazay; Yehuda Lindell. ‘Efficient Secure Two-Party Protocols’. Springer, 2010. ISBN 978-3-642-14302-1]. Garbled circuits and oblivious transfer are preferably used for secure computations between two parties, and secret sharing between 3 or more parties; ORAMs are particularly suitable for secure computation on large arrays of encrypted data; and homomorphic encryption can only be used for small quantities of data such as prices, given its high computational costs.

According to a further embodiment, said computer implemented method for securely computing one or more financial instruments further comprising at least one or more of: rewriting fields, terms and/or values of financial instruments; and generating secure computation programs; and customising existing secure computation programs; and signing secure computation programs; and including secure computation programs within said financial instruments. According to this embodiment, one of its advantages is that conventional financial instruments can be converted to financial instruments ready for secure computation, that is, with some fields encrypted and/or containing secure computation programs. Another advantage is that secure computation programs can be included within said financial instruments during the conversion, said secure computation programs specially tailored to the converted financial instruments.

According to a further embodiment, said computer implemented method for securely computing one or more financial instruments further comprising at least one or more of: creating an aggregate financial instrument; and generating secure computation programs; and customising existing secure computation programs; and signing secure computation programs; and including secure computation programs within said financial instruments. According to this embodiment, one of its advantages is that aggregate financial instruments can be created from collections of other financial instruments, given rise to new ways of packaging financial instruments respecting the secrecy and privacy of the financial instruments that are being aggregated. Another advantage is that secure computation programs can be included within said aggregate financial instruments during the aggregation process, said secure computation program specially tailored to the converted financial instruments.

According to a further embodiment, said computer implemented method for securely computing one or more financial instruments further comprising at least one or more of: obtaining existing proofs of secure computation programs; and generating proofs of secure computation programs; and including proofs of secure computation programs within said financial instruments; and validating proofs of secure computation programs; and generating proof-certified secure computation programs; and customising existing proof-certified secure computation programs; and signing proof-certified secure computation programs; and including proof-certified secure computation programs within said financial instruments. According to this embodiment, its main advantage is that secure computation programs are complemented with proofs, which can be obtained from a library of pre-defined proofs, automatically generated and/or later validated before or during the execution of secure computation programs. Another advantage is that secure computation programs can be included within said proof-certified financial instruments during the proof generation process, said secure computation programs specially tailored to the specifications of the proofs demanded by a particular financial instrument.

According to a further preferred embodiment, said computer implemented method for securely computing one or more financial instruments further comprising at least one or more of: obtaining existing proofs of encrypted secure computation programs; and generating proofs of encrypted secure computation programs; and including proofs of encrypted secure computation programs within said financial instruments; and validating proofs of encrypted secure computation programs; and using privacy-preserving protocols for encrypted secure computation programs: reusable garbled circuits, circuits over secret sharing schemes, circuits over homomorphic encryption schemes, cryptographically-secure obfuscation, and combinations thereof; and generating encrypted proof-certified secure computation programs; and customising existing encrypted proof-certified secure computation programs; and signing encrypted proof-certified secure computation programs; and including encrypted proof-certified secure computation programs within said financial instruments. According to this embodiment, one advantage is that secure computation programs are complemented with proofs, which can be obtained from a library of pre-defined proofs, automatically generated and/or later validated before or during the execution of secure computation programs. The main benefit is the variety of supported cryptographic techniques for encrypted secure computation, combining different security models with the shortcomings of some cryptographic techniques resolved by the benefits of others: that is, these cryptographic techniques allow to store secure computation programs within the financial instruments in an encrypted state, so that the parties executing the programs do not learn anything substantial about the executed code under different assumptions and security models.

According to a further embodiment, a financial instrument management system executed on at least one computer device, comprising a secure processing module configured to obtain one or more financial instruments, and to check the correctness of said obtained financial instruments, and to keep the financial instruments resulting from the secure cryptographic module; and a secure cryptographic module configured to receive said financial instruments from said secure processing module, and to encrypt and/or decrypt terms and/or values of said financial instruments, and to execute one or more secure computation programs on said financial instruments using at least one privacy-preserving protocol from a group of privacy-preserving protocols consisting of: garbled circuits and oblivious transfers, GMW circuits, secret sharing, homomorphic encryption, oblivious random access machines (ORAMs), and combinations thereof; garbled circuits and oblivious transfer being the preferred one. According to this embodiment, one advantage is that the secure processing module manages the financial instruments and check their correctness: these capabilities are separated from the cryptographic ones, to reduce the trusted codebase and prevent security risks. According to this embodiment, another advantage is that all the cryptographic capabilities are on the same module, therefore the execution of secure computation programs can work together with the encryption and decryption of terms of values of the financial instruments.

According to a further embodiment, said financial instrument management system wherein said secure processing module is additionally configured to rewrite fields, terms and/or values of financial instruments, and wherein the secure cryptographic module is additionally configured to at least one or more of: generate secure computation programs; and customise existing secure computation programs; and sign secure computation programs; and include secure computation programs within said financial instruments. According to this embodiment, one advantage is that rewriting financial instruments is separated from the creation and inclusion of secure computation programs. Another advantage is that conventional financial instruments are rewritten changing the names of the fields, so they could still be retro-compatible with software that is not aware of the techniques used in the present disclosure.

According to a further embodiment, said financial instrument management system wherein the secure processing module is additionally configured to create an aggregate financial instrument and wherein the secure cryptographic module is additionally configured to at least one or more of: generate secure computation programs; and customise existing secure computation programs; and sign secure computation programs; and include secure computation programs within said financial instruments. According to this embodiment, one advantage is that the creation of aggregate financial instruments is separated from the creation and inclusion of secure computation programs. Another advantage is that conventional financial instruments can be aggregated with financial instruments ready for secure computation, with no distinctions between them.

According to a further embodiment, said financial instrument management system wherein the secure cryptographic module is additionally configured to at least one or more of: obtain existing proofs of secure computation programs; and generate proofs of secure computation programs; and include proofs of secure computation programs within said financial instruments; and validate proofs of secure computation programs; and generate proof-certified secure computation programs; and customise existing proof-certified secure computation programs; and sign proof-certified secure computation programs; and include proof-certified secure computation programs within said financial instruments. According to this embodiment, the main advantage is that the generation and inclusion of proofs go together with the creation and inclusion of secure computation programs: shorter and faster proofs can be tailored to the given secure computation programs, and vice versa; and proofs can be validated during the execution of secure computation programs.

According to a further preferred embodiment, said financial instrument management system wherein the secure cryptographic module is additionally configured to at least one or more of: obtain existing proofs of encrypted secure computation programs; and generate proofs of encrypted secure computation programs; and include proofs of encrypted secure computation programs within said financial instruments; and validate proofs of encrypted secure computation programs; and use privacy-preserving protocols for encrypted secure computation programs: reusable garbled circuits, circuits over secret sharing schemes, circuits over homomorphic encryption schemes, cryptographically-secure obfuscation, and combinations thereof; and generate encrypted proof-certified secure computation programs; and customise existing encrypted proof-certified secure computation programs; and sign encrypted proof-certified secure computation programs; and include encrypted proof-certified secure computation programs within said financial instruments. According to this embodiment, the main advantage is that techniques for encrypted secure computation are supported together with proofs, thus proofs can be validated during the execution of encrypted secure computation programs, even if they executing party does not really know what is being executed.

According to a further preferred embodiment, said financial instrument management system is implemented as an add-in to an existing spreadsheet computer program, said add-in comprising at least the secure processing module; or as an entirely new spreadsheet computer program; or as a web application. In an exemplary embodiment, the present disclosure is implemented as an add-in to Microsoft® Excel®: according to this embodiment, its main advantage is that financial instruments enhanced with secure computation are presented to the user in a well-known GUI that can be easily extended and complemented with other financial instruments and financial systems of the user.

The present disclosure has been summarily described in the preceding paragraphs: it relates to financial instruments, and in particular it relates to systems and methods and financial instruments enhanced to securely compute on the information contained within said financial instruments and on other external data sources; the secrecy and privacy of secure computation programs may also be guaranteed. Secure computation over private data enables to calculate and mine datasets preserving the privacy of their data, providing secure property rights for data and secure computation programs. In the present disclosure, these advanced data processing features are incorporated onto financial instruments, improving the state of the art of finance by offering better financial instruments to lower risks and improve their yields, due to the combination of one or more of the following factors: use of secret datasets; use of secret functions and secure computation programs for valuations and/or trading strategies, among other possible uses; providing guarantees in the form of mathematical proofs accompanying said financial instruments regarding valuable properties about them (vg. that they follow some specifications and/or restrictions); and aggregating collections of financial instruments under a newly encrypted one as a novel way to package financial instruments. And regarding the field of secure computation, the present disclosure improves the current state of the art by introducing automated theorem provers and the rigor of mathematical proofs to secure computation programs, providing novel and inventive uses such as encrypted secure computation programs that can be executed on private datasets without exactly knowing what the secure computation program would do but with assurances that the execution will be well-behaved. Other financial instruments, methods, systems, modules, media and/or computer program products according to embodiments of the present disclosure will be or become apparent to one with skill in the art upon review of the following drawings and detailed description. It is intended that all such additional financial instruments, systems, modules, methods, media and/or computer program products be included within this description, be within the scope of the present disclosure, and be protected by the accompanying claims.

### BRIEF DESCRIPTION OF DRAWINGS

The above and other objects, features and advantages of the present disclosure will become apparent from the following description of embodiments, in which:

FIG. 1 Flow diagram of the secure computation of a financial instrument.

FIG. 2 Flow diagram of the automatic conversion from a conventional financial instrument to a financial instrument ready for secure computation.

FIG. 3 Flow diagram of the automatic aggregation of conventional financial instruments and/or financial instruments ready for secure computation.

FIG. 4 Flow diagram of the load and use of financial instruments ready for secure computation from a spreadsheet enabled for secure computation.

FIG. 5 is a non-limiting exemplary schematic diagram of a computer system that executes secure computation on financial instruments.

FIG. 6 is a flow diagram of the generation of Proof-Certified Circuits.

### DESCRIPTION OF EMBODIMENTS

The inventive subject matter is described with specificity to meet statutory requirements. However, the description itself is not intended to limit the scope of this patent. Rather, it is contemplated that the claimed subject matter might also be embodied in other ways, to include different steps or combinations of steps similar to the ones described in this document, in conjunction with other present or future technologies.

Details of the cryptographic protocols, primitives and techniques used in the present disclosure can be found in the papers cited herein and in the following books [Manoj M. Prabhakaran; Amit Sahai. ‘Secure Multi-Party Computation’. IOS Press, 2013. ISBN 978-1-61499-168-7; Thomas Schneider. ‘Engineering Secure Two-Party Computation Protocols’. Springer, 2012. ISBN 978-3-642-30041-7; Carmit Hazay; Yehuda Lindell. ‘Efficient Secure Two-Party Protocols’. Springer, 2010. ISBN 978-3-642-14302-1]. Further details of the cryptographic protocols, primitives and techniques used in the present disclosure appear in the following publications, the contents of which are incorporated herein by way of reference:
Oblivious Transfer: in some example, Oblivious Transfer (OT) of I-bit strings is a secure computation protocol [M. Naor and B. Pinkas. “Efficient oblivious transfer protocols”. ACM-SIAM SODA'01, pages 448-457], in which the chooser inputs a vector of choice bits r and the server inputs a vector of pairs of I-bit strings (x₀,x₁), i=1 . . . n. At the end of the protocol, the chooser learns the selected strings (xᵣ)ᵢ, i but nothing about the other strings x₍₁₋ᵣ_{_}ᵢ₎, whereas the sender learns nothing about the choices
Yao's Garbled Circuit Protocol: in some examples, Yao's garbled circuit protocol is a secure computation that given a function ƒ to be securely evaluated (SFE) represented as a boolean circuit [A. C. Yao. “How to generate and exchange secrets”. FOCS'86, pages 162-167] allows two parties, a garbler and an evaluator, its jointly computation on their respective private inputs X and Y: for each wire of the boolean circuit of ƒ, the garbler chooses two random wire labels for the values 0 and 1. Then, the garbler obliviously sends the wire labels to the evaluator for their inputs, using an oblivious transfer protocol in the case of the evaluator's inputs so that the garbler does not learn the evaluator's inputs. The garbler also creates and sends to the evaluator a garbled Table Tᵢ for each gate Gᵢ of ƒ so that given the wire labels for Gᵢ's inputs, Tᵢ only allows to recover the wire label of the corresponding output of Gᵢ. Using the received garbled tables and wire labels of the inputs, the evaluator proceeds to evaluate the garbled circuit gate by gate until it obtains the labels of the output wires: for these, the garbler sends mappings of their plain values to the evaluator to recover the desired computed ƒ(x,y). Note that in Secure Function Evaluation (SFE), the function is known by both parties (garbler and evaluator): in case it's desired that the function remains private (PF-SFE, Private Function-Secure Function Evaluation), a Universal Circuit capable of simulating any circuit given the description of function ƒ could be used, in such a way that the secure evaluation of the Universal Circuit completely hides the functionality of ƒ, including its topology. Multiple garbled circuit optimizations to improve the performance have been devised over the years, the following ones being the most notable: Point-and-Permute [M. Naor, B. Pinkas, and R. Sumner. “Privacy preserving auctions and mechanism design”. ACM Conference on Electronic Commerce, pages 129-139. ACM, 1999], Free-XOR [V. Kolesnikov and T. Schneider. “Improved garbled circuit: Free XOR gates and applications”. ICALP'08, volume 5126 of LNCS, pages 486-498], Garbled Row Reductions [B. Pinkas, T. Schneider, Nigel P. Smart, and Stephen C. Williams. “Secure two-party computation is practical”. ASIACRYPT 2009, volume 5912 of LNCS, pages 250-267], Fixed-key with AES-NI [M. Bellare, V. Hoang, S. Keelveedhi, and P. Rogaway. “Efficient garbling from a fixed-key block cipher”. IEEE Symposium of Security and Privacy, pages 478-492, 2013] and Half-Gates [S. Zahur, M. Rosulek, D. Evans. “Two Halves Make a Whole—Reducing Data Transfer in Garbled Circuits Using Half Gates”. EUROCRYPT 2015, pages 220-250]. Yao's garbled circuits and oblivious transfers are the default and preferred techniques for secure computation.
GMW Protocol: in some examples, the Goldreich-Micali-Wigderson protocol is a secure computation protocol in which given a function ƒ to be securely evaluated (SFE) represented as a Boolean circuit consisting of XOR and AND gates [O. Goldreich, S. Micali, and A. Wigderson. “How to play any mental game, or a completeness theorem for protocols with honest majority”. 19th Annual ACM Symposium on Theory of Computing (STOC), pages 218-229] it allows n-parties to jointly compute said function respecting the privacy of their inputs: it's considered the n-party case of the previously described Yao's Garbled Circuit Protocol. The protocol starts setting shares on the input wires: party Pᵢ provides input s_{w} on wire w by choosing random s_{wj} for j different from i, setting its s_{wj}=s_{w}XOR(XOR_{j≠i}s_{wj}) and sending s_{wj} to Pⱼ. Then, shares on internal wires are computed inductively: for XOR gates, each party Pᵢ computes s_{wi}=sᵤᵢXORsᵥᵢ, with w being the output wire and u and v being the input wires; for AND gates, Pⱼ chooses a random bit (cⱼ)^{{i,j}} and computes the four values of Pᵢ's shares, (cⱼ)^{{i,j}}, (cⱼ)^{{i,j}}XORsᵤⱼ, cⱼ^{{i,j}}XORsᵥⱼXORsᵤⱼ, so that party Pᵢ obtains the correct value (cᵢ)^{{i,j}} from Pⱼ by executing an oblivious transfer with Pⱼ, and finally each party Pᵢ computes s_{wi}I=sᵤᵢsᵥᵢ+Σ_{j≠i}(cᵢ)^{{i,j}}. After all the internal wires have been calculated, the final value s_{w} of a sharing of an output wire w can be reconstructed by privately pooling the private shares of all the parties.
Secret Sharing: in some examples, secret sharing refers to methods for distributing a secret amongst a group of parties, each of whom is allocated a share of the secret; the secret can be reconstructed when only a sufficient number of shares are combined together. More formally, [x] denotes the secret-shared value x in F_{q} among parties p₁, . . . , p_{B} such that any Ceil((B+q)/2) of those can recover the secret. Regarding basic operations, [x]+[y], [x]+c and c[x] can be computed locally by each party pᵢ using her shares of x and y while the computation [x][y] is mandatorily interactive for Ceil((B+1)/2) parties. Details for the currently most efficient implementation of protocols based on secret sharing, optimized with shared MACs and a preprocessing offline phase that interchanges random data between the parties, can be found in [Ivan Damgard; Marcel Keller; Enrique Larraia; Christian Miles; Nigel Smart. ‘Implementing AES via an actively/covertly secure dishonest-majority MPC protocol’ SCN 2012, volume 7485 of LNCS 7485, pages 241-263; Ivan Damgard; Marcel Keller; Enrique Larraia; Valerio Pastro; Peter Scholl; Nigel Smart. ‘Practical Covertly Secure MPC for Dishonest Majority or: Breaking the SPDZ Limits’ ESORICS 2013, pp. 1-18; Ivan Damgard; Valerio Pastro; Nigel Smart; Sarah Zakarias. ‘Multiparty computation from Somewhat Homomorphic Encryption’ CRYPTO 2012, LNCS 7417, pp. 643-662; Marcel Keller; Peter Scholl; Nigel Smart. ‘An architecture for practical actively secure MPC with dishonest majority’ Computer & Communications Security 2013, pp. 549-560].
Homomorphic Encryption: In some examples, homomorphic encryption refers to methods of encryption allowing computations to be carried out on encrypted data. More formally, with c=E_{A}_{_}ₚₖ(x) denoting the encryption of x under the public key of party A producing encrypted data c and D_{A}_{_}ₚₖ(c) denoting the decryption of said encrypted data c, when using a fully homomorphic encryption schemes the following relationships hold: D_{A}_{_}ₚₖ(E_{A}_{_}ₚₖ(x)+E_{A}_{_}ₚₖ(y))=x+y for the sum operation and D_{A}_{_}ₚₖ(E_{A}_{_}ₚₖ(c)·E_{A}_{_}ₚₖ(y))=x·y for the multiplication operation; non-fully homomorphic encryption schemes refer to the case when just one of the two previous relationships hold. In some examples, homomorphic encryption can be extended with secret sharing: at least a variable can be secret shared between the parties of a cryptographic protocol using homomorphic encryption. Before the advent of Fully Homomorphic Encryption, practical systems using non-fully homomorphic encryption were of no utility: in [Pierre-Alain Fouque; Jacques Stern; Geert-Jan Wackers. ‘CryptoComputing with rationals’, Proceedings of the 6th International Conference on Financial Cryptography, pp 136-146, 2002], the addition of two rational numbers was not possible and the multiplication can only be done to a known integer. After the introduction of Fully Homomorphic Encryption, it became possible to compute general functions but with performance some orders of magnitude slower than those achieved by the state of the art of secret sharing schemes or garbled circuits, although still being more efficient on a round complexity perspective: details for their efficient implementation and their tradeoffs with other schemes can be found in [S. Myers, M. Sergi, and Abhi Shelat. ‘Threshold fully homomorphic encryption and secure computation’. IACR Cryptology ePrint Archive, 2011:454, 2011; Craig Gentry; Shai Halevi; Nigel Smart. ‘Fully homomorphic encryption with polylog overhead’. EUROCRYPT 2012, LNCS 7237, pp. 465-482; Gilad Asharov; Abshishek Jain; Adriana Lopez-Alt; Eran Tromer; Vinod Vaikuntanathan; Daniel Wichs. ‘Multiparty computation with low communication, computation and interaction via threshold FHE’. EUROCRYPT 2012, LCNS 7237, pages 483-501; Ashish Choudhary; Emmanuela J. Orsini; Arpitra Petra; Nigel Smart. ‘Between a Rock and a Hard Place: Interpolating Between MPC and FHE’, Advances in Cryptology—ASIACRYPT 2013, LNCS 8270, pp. 221-240]. To allow that encrypted data could be used under multiple public/private keys, various approaches can be considered. In one implementation, proxy re-encryption techniques are implemented [Matt Blaze, Gerrit Bleumer, Martin Strauss. “Divertible protocols and atomic proxy cryptography”. EUROCRYPT 1998, LNCS 1403, pages 127-144, 1998; Qingji Zheng, Xinwen Zhang. “Multiparty Cloud Computation”. CoRR abs/1206.3717, 2012; Bharath K. Samanthula, Gerry Howser, Yousef Elmehdwi, Sanjay Madria. “An efficient and secure data sharing framework using homomorphic encryption in the cloud”. Proceedings of the First International Workshop on Cloud Intelligence, Article No 8, 2012]: these techniques allow the re-encryption under a new and more general proxy re-encryption key of the encrypted data which was previously encrypted under the key of just one user. In another implementation, secure distributed key generation techniques [Ian Goldberg. “Distributed Key Generation in the Wild”. Cryptology ePrint Archive 2012/377, July 2012] are used, which allow the creation of common public/private keys between a set of users/clients. In another implementation, multikey fully homomorphic encryption is used to evaluate any circuit on encrypted data that might be encrypted under different public keys [Adriana Lopez-Alt, Eran Tromer, Vinod Vaikuntanathan. “On-the-fly multi-party computation on the cloud via multi-key fully homomorphic encryption”. Proceedings of the Symposium on Theory of Computing 2012, pages 1219-1234]. Circuits can also be evaluated with homomorphic encryption, as the following papers show [Vladimir Kolesnikov, Ahmad-Reza Sadeghi, Thomas Schneider. “How to Combine Homomorphic Encryption and Garbled Circuits”. 1st International Workshop on Signal Processing in the EncryptED Domain, SPEED'09; Craig Gentry, Shai Halevi, Nigel P. Smart. “Homomorphic Encryption of the AES Circuit”. CRYPTO 2012, LNCS 7417, pages 850-867].
ORAM: in some examples, Oblivious Random Access Machines refers to methods of hiding access patterns to a server storing encrypted information. More formally, input y of the client is a sequence of data items denoted by ((v₁,x₁), . . . , (vₙ,xₙ)), and a sequence of read operations to retrieve the data of the item indexed at a position and write operations to set the value of an index position; the access pattern A(y) is the sequence of accesses to the server storage system, containing both the indices accessed in the system and the data items read or written; an oblivious RAM system is considered secure if for any two inputs y,y′ of the client, of equal length, the access patterns A(y) and A(y′) are computationally indistinguishable for anyone but the client. In some implementations of ORAMs, techniques are used such as oblivious sorting algorithms and cuckoo hashing to map each item to two potential entries of a hash table. ORAMs exhibit significant speed-ups in comparison to the shortcomings of the circuit approach for Secure Computation because there are functions that are less efficient when implemented as a circuit of possibly very wide breadth and depth, as in the case of accessing an array for just one position, which has constant complexity in the ORAM model but linear complexity inherent in the circuit model. Details for the currently most efficient implementations based on ORAMs appear in [Craig Gentry, Kenny A. Goldman, Shai Halevi, Charanjit S. Jutla, Mariana Raykova, Daniel Wichs. ‘Optimizing ORAM and Using It Efficiently for Secure Computation’. Privacy Enhancing Technologies 2013, pp. 1-18; Xiao Shaun Wang, T.-H. Hubert Chan, Elaine Shi. ‘Circuit ORAM: On Tightness of the Goldreich-Ostrovsky Lower Bound’. Cryptology ePrint Archive: Report 2014/672] and details regarding the practical compilation of programs to the ORAM-model of secure computation can be found in [Chang Liu, Yan Huang, Elaine Shi, Jonathan Katz, Michael Hicks. “Automating Efficient RAM-Model Secure Computation”. IEEE Symposium on Security and Privacy 2014, pages 623-638].
Cryptographically-Secure Obfuscation: An obfuscator O is an probabilistic compiler that takes a circuit C, or a program P, and produces a new inintelligible version O(C), or O(P): such a general definition is impossible, so a weaker form has to be used, indistinguishability obfuscation, albeit cryptographically-secure. In some examples, an indistinguishability obfuscator iO for a class of circuits C, or a program P, ensures that given any two equivalent circuits C₁ and C₂ contained in C, the two distributions iO(C₁) and iO(C₂) are indistinguishable. In [Sanjam Garg, Craig Gentry, Shai Halevi, Mariana Raykova, Amit Sahai, Brent Waters. “Candidate Indistinguishability Obfuscation and Functional Encryption for all circuits”. FOCS 2013, pages 40-49] is offered an iO for all circuits: it starts with an iO for polynomial-size and log-depth circuits transforming them into branching programs using Barrington's theorem, which is evaluated between two parties using an OT protocol; and combining the previous obfuscator with a fully homomorphic encryption scheme, it manages to obtain indistinguishability between the circuits. Another important cryptographic primitive to build cryptographically-secure obfuscation in conjunction with Fully Homomorphic Encryption is the cryptographic multi-linear map: to be deemed convenient for cryptographic applications, a cryptographic multi-linear map scheme consists of efficient procedures for instance-generation, element-encoding validation, group-operation and negation; security comes from the discrete logarithm being hard in the respective groups, and usually the multi-linear Decision Diffie Hellman should also be hard. Candidate constructions for multi-linear maps appear in [Sanjam Garg, Craig Gentry, Shai Halevi. “Candidate Multilinear Maps from Ideal Lattices”. Eurocrypt 2013, pages 1-17; Jean-Sébastien Coron, Tancrede Lepoint, Mehdi Tibouchi. “Practical multilinear maps over the integers”. Crypto 2013, pages 476-493; Craig Gentry, Sergey Gorbunov, Shai Halevi. “Graph-induced multilinear maps from lattices”. Theory of Cryptography 2015, pages 498-527]. A cryptographic multi-linear map is defined by: for k+1 cyclic groups G₁, . . . , G_{K}, G_{T} of the same order p, an k-multi-linear map e:G₁x . . . xGₖ→G_{T} has the following properties:
   For elements {gᵢ in Gᵢ}_{i=1, . . . ,k}, index i in [k] and integer α in Zₚ, it holds that e(g₁, . . . , α·gᵢ, . . . , gₖ)=α·e(g₁, . . . , gₖ).
   The map e is non-degenerate in the following sense: if the elements {gᵢ in Gᵢ}_{i=1, . . . ,k}, are all generators of their respective groups, then e(g₁, . . . , gₖ) is a generator of G_{T}.

The parameters of the system, cryptographic protocols and primitives are determined based on formulas as the ones included in the following papers [T. Kleinjung, Arjen K. Lenstra, D. Page, Nigel P. Smart. “Using the Cloud to Determine Key Strengths”. IACR Cryptology ePrint Archive, 2011:254, 2011; Arjen K. Lenstra, Eric R. Verheul. “Selecting Cryptographic Key Sizes”. Proceedings of PKC 2000, Lecture Notes in Computer Science Volume 1751, pp. 446-465] and current recommendations and best practices [Nigel P. Smart, Vicent Rijmen, Bogdan Warinschi, Gaven Watson. “Algorithms, Key Sizes and Parameters Report”. Technical Report of the European Union Agency for Network and Information Security Agency, 2013; Nigel P. Smart, et al. “ECRYPT II Yearly Report on Algorithms and Keysizes (2011-2012)”]. The system may automatically change these parameters to trade security for performance, and users of the system may override these parameters for ones of their choice.

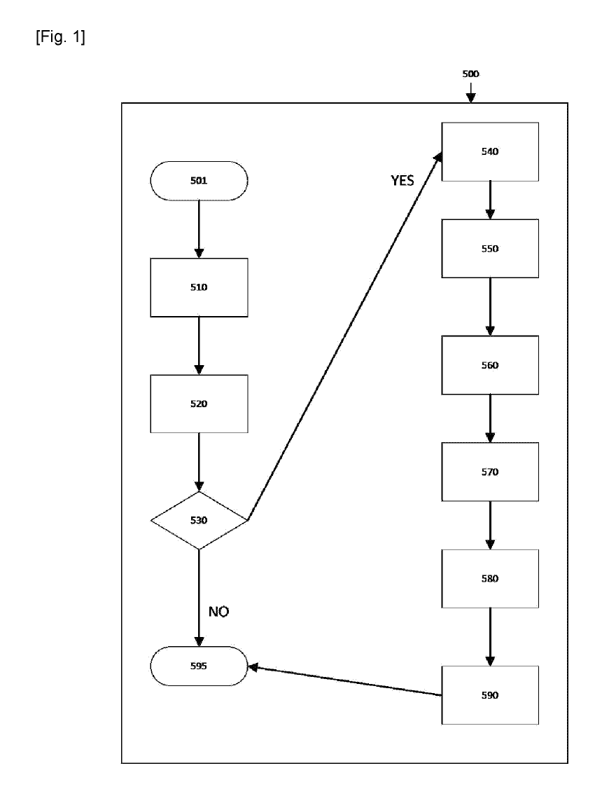

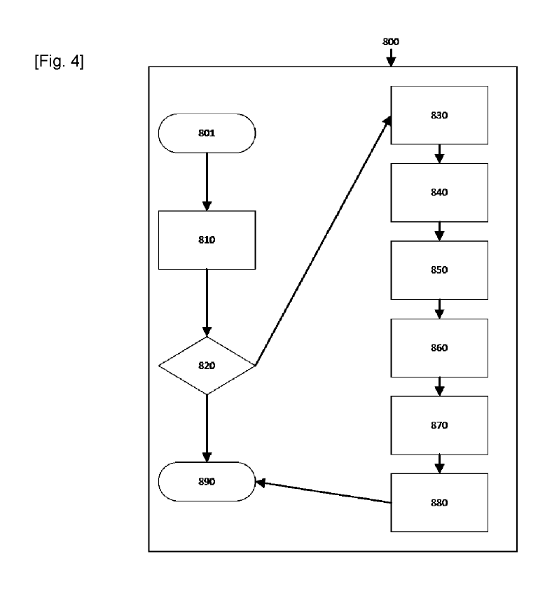

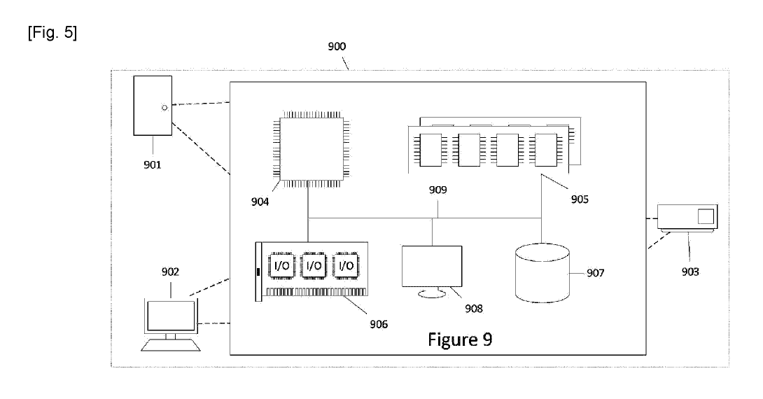

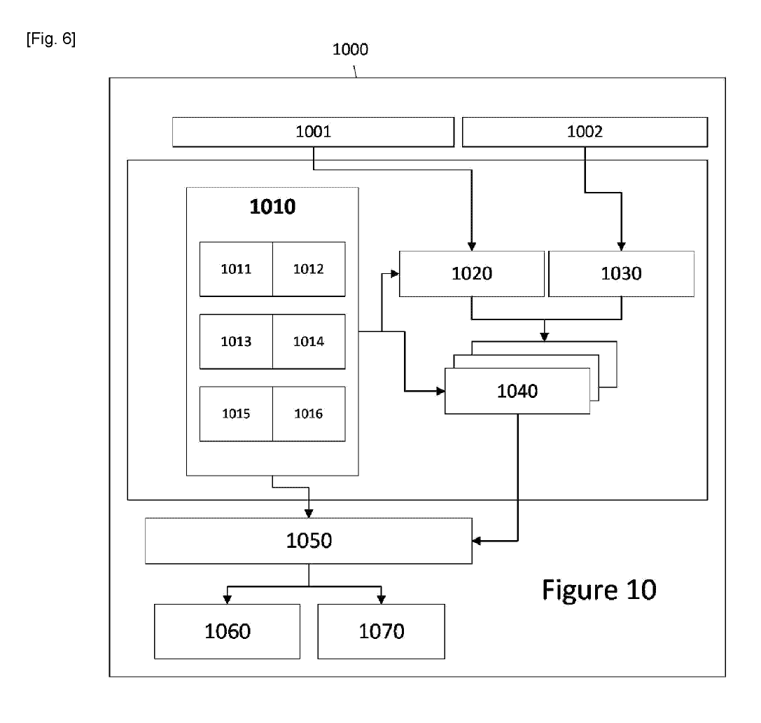

The following FIGS. 1-3 provide a step-by-step description of the present disclosure; FIG. 4 describes an exemplary user interface of the present disclosure; FIG. 5 provides an exemplary instantiation on a computer system; and FIG. 6 describes the generation of Proof-Certified Circuits.

Implementations of the present disclosure can be illustrated by way of examples. Included herein is a set of flow charts representative of exemplary methodologies for performing novel aspects of the disclosed system. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

FIG. 1 illustrates a flow diagram 500 of the secure computation of a financial instrument in accordance to the present disclosure. At 501, the flow diagram starts: at 510, financial instruments are received from a network connection, or read from a filesystem; at 520, secure computation programs, as stored on the filesystem or taken from said financial instruments, are initialized. At 530, financial instruments are parsed and checked for correctness: in case any error is detected, the procedure stops at 595. At 540, encrypted terms and/or values are decrypted. At 550, external data from markets is retrieved as required by secure computation programs. At 560, the secure computation is carried out: at least a value is determined from said secure computation. At 570, data resulting from the secure computation is sent to the markets. At 580, terms and/or values of the financial instrument are encrypted back. At 590, the resulting financial instruments are sent to the network or stored locally on the filesystem. At 595, the procedure stops.

The following algorithm illustrates claims 1, 6 and 11.

Algorithm 1. Secure Computation on Financial Instruments.

1.
a. The secure processing module obtains one or more financial instruments:
   i. Said secure processing module listens for incoming connections that contain financial instruments.
   ii. Said secure processing module watches for changes on the filesystem, and reads files whenever there is a change.
b. Secure computation programs are initialized by the secure cryptographic module:
   i. Secure computation programs could exist within financial instruments, or completely standalone on the filesystem.
   ii. Memory is allocated and reserved.
c. Financial instruments are parsed and checked for correctness by the secure processing module:
   i. Syntactic validation is executed.
   ii. Semantic validation is executed.
   iii. Numeric values are checked against ranges of market data to detect inconsistencies and outliers.
   iv. Cryptographic signatures are checked, and the general correctness of the encrypted data.
   v. In case of error on any of the previous steps, the procedure stops.
d. Financial instruments are received by the secure cryptographic module from the secure processing module.
e. Encrypted terms and/or values are decrypted by the secure processing module (note that some financial instrument may not have any encrypted term and/or values, nor contain secure computation programs; that is, it's possible to carry out secure computation on conventional financial instruments by using secure computation programs stored on the filesystem):
   i. Keys to decrypt the encrypted values are retrieved.
   ii. The decryption process is executed: note that the encrypted data of some encryption methods do not have to be decrypted (eg. homomorphic encryption and the encrypted shares of a secret sharing scheme).
f. External data is retrieved from markets, as required by secure computation programs:
   i. Exemplarily, current public values of indices, shares, bonds, options, futures and other financial instruments are obtained.
   ii. Exemplarily, the secret encrypted values of other financial instruments could be retrieved and used in the secure computation of the present financial instrument.
g. Secure computation programs are executed by the secure cryptographic module, that is, for every secure computation program:
   i. Get the type of secure computation program, as any of the described within the present disclosure, but not strictly limited to them: Yao's garbled circuits and oblivious transfers, GMW circuits, secret sharing, homomorphic encryption, ORAMs, or combinations thereof; garbled circuits and oblivious transfer being the preferred one.
   ii. Check digital signatures of secure computation programs: if found wrong, stop the execution.
   iii. Execute said secure computation programs:
      1. Given the secure computation program, the financial instrument management system executes it using the adequate library from the libraries for secure computation of the financial instrument management system: said library could be proprietary or open-source, in case more security through transparency and peer-examination of the critical source code is desired.
      2. The secure computation program may need access to external data sources, encrypted or not, during its execution: by default is granted, unless a policy explicitly denies it.
      3. At least a value is determined from said secure computation.
h. Data resulting from the secure computation is sent to the markets by the secure cryptographic module.
   i. Exemplarily, orders to take exposure in any financial instrument, independently of their readiness for secure computation.
i. Terms and/or values of the financial instrument are encrypted back by the secure cryptographic module:
   i. Keys to encrypt the encrypted values are retrieved.
   ii. The encryption process is executed: some encryption methods require the information to be encrypted back, such as authenticated symmetric encryption and public key encryption.
j. Financial instruments are received by the secure processing module from the secure cryptographic module.
k. The secure processing module sends to the network the resulting one or more financial instruments, or stores them locally on the filesystem.
   i. Alternatively, they could be deleted if they are deemed as not needed anymore

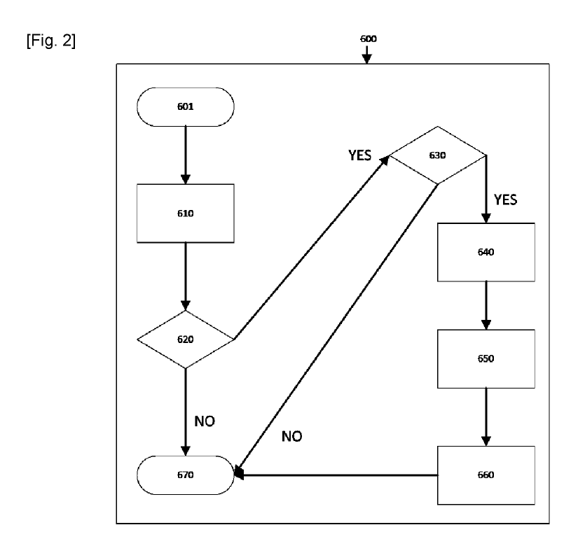

FIG. 2 illustrates a flow diagram 600 of the automatic conversion from a conventional financial instrument to a financial instrument ready for secure computation in accordance to the present disclosure. At 601, the procedure starts: at 610, financial instruments are received from a network connection, or read from a filesystem. At 620, financial instruments are parsed and checked for correctness. At 630, financial instruments are matched against templates specifically designed for the transformation of secure financial instruments: if no transformative template is found, the procedure stops at 670. At 640, the fields and/or terms of the conventional financial instrument are rewritten according to the template. At 650, values of the financial instrument are encrypted. At 660, the resulting financial instrument is sent to the network or stored locally on the filesystem. At 670, the procedure stops.

The following algorithm illustrates claims 2, 7 and 12.

Algorithm 2. Conversion of Financial Instrument for Secure Computation.

1.
a. The secure processing module obtains one or more financial instruments:
   i. Said secure processing module listens for incoming connections that contain financial instruments.
   ii. Said secure processing module watches for changes on the filesystem, and reads files whenever there is a change.
b. Financial instruments are parsed and checked for correctness by the secure processing module:
   i. Syntactic validation is executed.
   ii. Semantic validation is executed.
   iii. Numeric values are checked against ranges of market data to detect inconsistencies and outliers.
   iv. Cryptographic signatures are checked, and the general correctness of the encrypted data.
   v. In case of error on any of the previous steps, the procedure stops.
c. Financial instruments are matched against templates specifically designed for the transformation of secure financial instruments by the secure processing module: if no transformative template is found, the procedure stops. For every financial instrument:
   i. The type of financial instrument is determined (eg. option, swap, swaption, . . . ).
   ii. The library of transformative templates is searched for said type.
   iii. The transformative template is retrieved, or the procedure stops.
d. Fields and/or terms of the financial instruments are rewritten by the secure processing module according to the template:
   i. The names of fields is changed.
   ii. Fields are added.
   iii. Fields are removed.
   iv. And if necessary, new documents describing financial instruments dependant on the processed financial instrument may be created.
e. Financial instruments are received by the secure cryptographic module from the secure processing module.
f. Values of the financial instruments are encrypted by the secure cryptographic module:
   i. Encrypting values, noting that the process depends on the encryption method:
      1. Obtain the keys for encryption: if the financial instrument will be used by third parties, use the public keys of said third parties to encrypt the values, as retrieved from a public key repository. If secret shares will be used to store encrypted information on the financial instrument, obtain them by choosing from a list of pre-calculated secret shares.
      2. Encrypt the values of the financial instrument and replace the unencrypted values by the encrypted ones, including changing the tags/fields referencing said encrypted values.
   ii. If a secure computation program were to be stored within the financial instrument (eg. a default secure program containing the method for the valuation of the financial instrument; or a default trading strategy for said financial instrument):
      1. If the secure computation program is to be digitally signed, generate said signature.
      2. Create new fields within the financial instrument to store the secure computation program and the type of secure computation program to be used.
      3. Marshal the secure computation program and store it within said fields.
g. Financial instruments are received by the secure processing module from the secure cryptographic module.
h. The secure processing module sends to the network the resulting one or more financial instruments, or stores them locally on the filesystem.

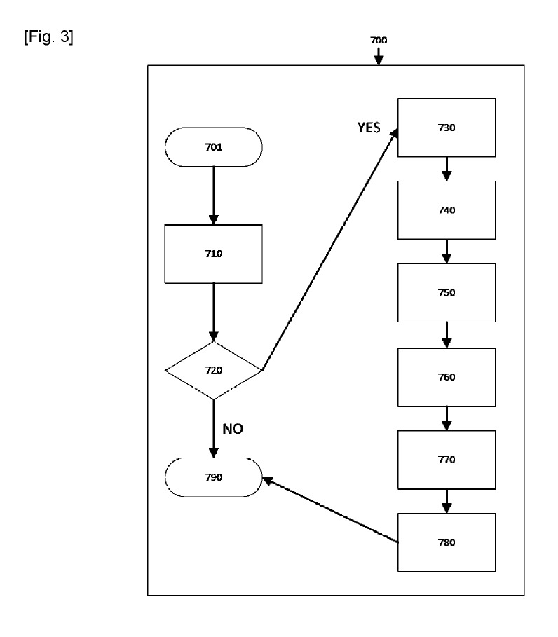

FIG. 3 illustrates a flow diagram 700 of the automatic aggregation of conventional and financial instruments ready for secure computation in accordance to the present disclosure. At 701, the procedure starts: at 710, financial instruments are received from a network connection, or read from a filesystem. At 720, said financial instruments are parsed and checked for correctness: in case any error is detected, the procedure stops at 790. At 730, a new financial instrument is created to store the aggregated data of the financial instruments. At 740, references to the financial instruments are stored in the aggregate financial instrument. At 750, values of the aggregate financial instrument are encrypted. At 760, values of the referenced financial instruments are encrypted: proceed as in the previous detailed steps with each referenced value. At 770, all the financial instruments are packaged within the same file, and at 780 the package is sent to the network or stored locally on the filesystem. At 790, the procedure stops.

The following algorithm illustrates claims 3, 8 and 13.

Algorithm 3. Aggregation of Financial Instruments for Secure Computation.

1.
a. The secure processing module obtains one or more financial instruments:
   i. Said secure processing module listens for incoming connections that contain financial instruments.
   ii. Said secure processing module watches for changes on the filesystem, and reads files whenever there is a change.
b. Financial instruments are parsed and checked for correctness by the secure processing module:
   i. Syntactic validation is executed.
   ii. Semantic validation is executed.
   iii. Numeric values are checked against ranges of market data to detect inconsistencies and outliers.
   iv. Cryptographic signatures are checked, and the general correctness of the encrypted data.
   v. In case of error on any of the previous steps, the procedure stops.
c. A new financial instrument is created by the secure processing module to store the aggregated data of the financial instruments:
   i. Fields are created to store mean, median and percentile values, among other kind of aggregations.
d. References to the financial instruments are stored in the aggregate financial instrument by the secure processing module. That is, for every financial instrument:
   i. Said financial instrument is checked for inclusion.
   ii. A reference to said financial instrument is stored in the aggregate financial instrument.
e. Financial instruments are received by the secure cryptographic module from the secure processing module.
f. Values of the aggregate financial instrument are encrypted by the secure cryptographic module:
   i. If the values weren't encrypted, and depending on the encryption method:
      1. Obtain the keys for encryption: if the financial instrument will be used by third parties, use the public keys of said third parties to encrypt the values, as retrieved from a public key repository. If secret shares will be used to store encrypted information on the financial instrument, obtain them by choosing from a list of pre-calculated secret shares.
      2. Said values are aggregated.
      3. Encrypt the values of the financial instrument and replace the unencrypted values by the encrypted ones, including changing the tags/fields referencing said encrypted values.
   ii. If the values were encrypted, and depending on the encryption method:
      1. If the encryption method used didn't allow re-encryption without decryption (eg. classic public key encryption), encrypted values will have to be de-encrypted and then proceed as in the previous steps.
      2. If the encryption method used allowed re-encryption without decryption (eg. homomorphic encryption), aggregate the values without decrypting said encrypted values.
   iii. If secure computation programs were to be stored within the financial instrument (eg. a default secure computation program containing the method for the valuation of the financial instrument; or a default trading strategy for said financial instrument):
      1. If the secure computation program is to be digitally signed, generate said signature.
      2. Create new fields within the financial instrument to store the secure computation program and the type of secure computation program to be used.
      3. Marshal the secure computation program and store it within said fields.
g. Values of the referenced financial instruments are encrypted by the secure cryptographic module:
   i. Proceed as in the previous detailed steps with each referenced value.
h. Financial instruments are received by the secure processing module from the secure cryptographic module.
i. All the financial instruments are packaged by the secure processing module within the same file.
j. The secure processing module sends to the network the resulting packaged financial instrument, or stores it locally on the filesystem.

FIG. 4 illustrates a flow diagram 800 of the load and use of secure financial instruments from a spreadsheet enabled for secure computation in accordance to the present disclosure. At 801, the procedure starts: an add-in may be loaded within a spreadsheet software package or a new spreadsheet program with specific functionality for secure computation could be used. At 810, a financial instrument ready for secure computation is received from a network connection, or read from a filesystem. At 820, said financial instrument is parsed and checked for correctness: the validation is syntactic, semantic and numeric values are checked against market data to detect inconsistencies and outliers; cryptographic signatures are also checked; in case any error is detected, the procedure stops at 890. At 830, a template for spreadsheet presentation is selected matching the type of financial instrument: different instruments have different fields and requirements to present them. At 840, the financial instrument is shown within the spreadsheet using its corresponding template. At 850, features to carry out secure computations according to the given financial instrument are enabled: for example, trading according to the financial instrument; or securely compute against other financial instruments for simulation or back-tracking purposes. At 860, the user may secure compute with the financial instrument following the steps described in FIG. 1 and Algorithm 1. At 870, modified values of the financial instrument are re-encrypted, if needed. At 880, the resulting financial instrument is sent to the network or stored locally on the filesystem. At 890, the procedure stops.

The following exemplary code listing illustrates a financial instrument in fpML with encrypted values and terms and secure computation programs in accordance to the present disclosure. The code listing shows an exemplary encryption of some of the terms of a conditional variance swap: the identity of the second party, party 2, has been encrypted (tags partyReference, receive rPartyReference, party and partyId) and all the numerical terms of the contract have also been encrypted (tags amountEncrypted, varianceStrikePrice, upperBarrier, lowerBarrier and vegaNotionalAmount). There is also a secure computation program for a trading strategy in the form of simple garbled circuit. The method of encryption used could be any of, but not restricted to: authenticated symmetric encryption; public key encryption; homomorphic encryption; shares of secret sharing scheme; garbled circuits; ORAMs; cryptographically-secure obfuscation; Proof-Certified Secure Programs and Circuits; and combinations thereof.

```
<?xml version=“1.0” encoding=“utf-8”?>
<requestConfirmation xmlns=“http://www.fpml.org/FpML-5/confirmation”
xmlns:xsi=“http://www.w3.org/2001/XMLSchema-instance” fpmlVersion=“5-2”
xsi:schemaLocation=“http://www.fpml.org/FpML-5/confirmation ../../fpml-
main-5-2.xsd http://www.w3.org/2000/09/xmldsig# ../../xmldsig-core-
schema.xsd”>
  <header>
    <messageId messageIdScheme=“http://www.party1.com/coding-
scheme/message-id”>12342342432</messageId>
    <sentBy messageAddressScheme=“http://www.party1.com/coding-
scheme/party-id”>32123</sentBy>
    <creationTimestamp>2015-09-09T04:03:00Z</creationTimestamp>
  </header>
  <isCorrection>false</isCorrection>
  <correlationId
correlationIdScheme=“http://www.test.com/conversationId”>PA/2015/09/09/1234
2342432</correlationId>
  <sequenceNumber>1</sequenceNumber>
  <trade>
    <tradeHeader>
      <partyTradeIdentifier>
        <partyReference href=“party001” />
        <tradeId tradeIdScheme=“http://www.parties.com/coding-scheme/trade-
id”>2313</tradeId>
      </partyTradeIdentifier>
      <partyTradeIdentifier>
        <partyReference
hrefEncrypted=“7ed5c64dfceb7728fd850c3280a5220c97afd846f66b75a4aae” />
        <tradeId tradeIdScheme=“http://www.parties.com/coding-scheme/trade-
id”>6569</tradeId>
      </partyTradeIdentifier>
      <tradeDate id=“d321”>2014-01-01</tradeDate>
    </tradeHeader>
    <varianceSwap>
      <varianceLeg>
        <payerPartyReference href=“party001” />
        <receiverPartyReference
hrefEncrypted=“7ed5c64dfceb7728fd850c3280a5220c97afd846f66b75a4aae” />
        <underlyer>
          <singleUnderlyer>
            <equity>
              <instrumentId
instrumentIdScheme=“http://www.fpml.org/schemes/4.1/instrumentId”>IBM</inst
rumentId>
              <description>IBM ordinary shares</description>
              <exchangeId
exchangeIdScheme=“http://www.fpml.org/schemes/4.1/exchangeId”>NYSE</exchang
eId>
            </equity>
          </singleUnderlyer>
        </underlyer>
        <settlementType>Cash</settlementType>
        <valuation>
          <valuationDate id=“FinalValuationDate”>
            <adjustableDate>
              <unadjustedDate>2013-05-23</unadjustedDate>
              <dateAdjustments>
<businessDayConvention>NotApplicable</businessDayConvention>
              </dateAdjustments>
            </adjustableDate>
          </valuationDate>
          <optionsPriceValuation>true</optionsPriceValuation>
        </valuation>
        <amount>
          <optionsExchangeDividends>true</optionsExchangeDividends>
          <additionalDividends>false</additionalDividends>
          <variance>
            <closingLevel>true</closingLevel>
            <varianceAmount>
              <currency>USD</currency>
<amountEncrypted>f80384bf3e7a851fbe3ea331663d4dfb76cc54e1ed4b974a531</amoun
tEncrypted>
            </varianceAmount>
<varianceStrikePriceEncrypted>82f57d36ea195749c6b2a390fcaf8f9cfa2c98a10d61b
e122dce9d</varianceStrikePriceEncrypted>
            <boundedVariance>
<realisedVarianceMethod>Previous</realisedVarianceMethod>
              <daysInRangeAdjustment>true</daysInRangeAdjustment>
<upperBarrierEncrypted>18413a75fc1e03845249048610d5702ee310e90f7289fdddcb8e
2</upperBarrierEncrypted>
<lowerBarrierEncrypted>d00eca55d46d84838e5b2f8f909edc8b3f4d6e327606608878dd
5f</lowerBarrierEncrypted>
            </boundedVariance>
            <exchangeTradedContractNearest>
              <instrumentId
instrumentIdScheme=“http://www.fpml.org/schemes/4.1/instrumentId”>IBM</inst
rumentId>
              <description>IBM ordinary shares</description>
              <currency>USD</currency>
              <exchangeId
exchangeIdScheme=“http://www.fpml.org/schemes/4.1/exchangeId”>NYSE</exchang
eId>
              <relatedExchangeId
exchangeIdScheme=“http://www.fpml.org/schemes/4.1/exchangeId”>CBOE</related
ExchangeId>
              <contractReference>CBOE SEP04 IBM EUROPEAN
OPTION</contractReference>
              <expirationDate>
                <adjustableDate>
                  <unadjustedDate>2013-07-25</unadjustedDate>
                  <dateAdjustments>
<businessDayConvention>NONE</businessDayConvention>
                  </dateAdjustments>
                </adjustableDate>
              </expirationDate>
            </exchangeTradedContractNearest>
<vegaNotionalAmountEncrypted>af860207075fc2c1087a59195ebdd36dae7339ea266a33
f</vegaNotionalAmountEncrypted>
          </variance>
        </amount>
      </varianceLeg>
    </varianceSwap>
  </trade>
  <party id=“party001”>
    <partyId>Party 1</partyId>
  </party>
  <party idEncrypted=“7ed5c64dfceb7728fd850c3280a5220c97afd846f66b75a4aae”>
<partyIdEncrypted>18c1ba475ef00b1c9d8ada3d31ff36b2e1983ae45a95a1f07dacd80f6
c7s</partyIdEncrypted>
  </party>
  <secProgram>
<type>SimpleGarbledCircuit</type>
<description>Trading strategy</description>
<program>a56468310ba26e6bf45b5ea3b4291d35f225bb8109af06965c9731858f4542155b
4f93e57dd1dc9837df75ceacc378a02f3860c5af012a45339c651f3e1b1888cf190b3980854
a66dfddd4767924319e09782e517d126261b51d91c37bfc6c7fc6d0a09ca583e7d37f5a0df5
50ff29e3ac64cb094e32a48a1558b44f6b409878a629e89886fc06f71aaacc5d2682b2d6e9a
ed964386cd53369340d9a513c2332f225a7806647119043ac88c0dee817f1e99a759aa6696f
2fe5cd6c64169cab4d10e7968f4f67571f79ce008ba9406b2aca83b439f5736d1fd79c5b32e
56d8f6cc7cd091d3ab690c83f8002f2acc617a881874504a77c8dcc44443069daaddd998720
2e18d31cfc0c3602d99e5c854312e15211671dd8cf6dfd6da2bebd2428f36d8b3ddb4471c75
98f3060a379a1aa2a10072bd5c23cd01d0fc2d39e599df4502bafa28567f4234a01ce403bc1
9876adbb7a8b7f80a818c2720ecccc451c9e28c5e02caf6f112369557f4e6fb2e24faca44</
program>
<proof>e5b74ef39645f993ae828a669454f6ad14ee4f7575ae38797fac06a2658d17477256
0f3bb24f0aef7188f007b7f605d35b08023ff8b569ab5d182f17facbaf8a5d776877f90c0dc
1d07e9bdb6de338967ce3a33d2c6c443e6bc3fac6ea8dde7defa766ec1a339b3a97901a1695
ec8e699fec4d90171b7c836813f3a1592a51d82884b924fdd55143fa5c16991a46ecfae9d4f
28517161cb55a7e5939562c45c423b02ce4d34c2d12d569c45d517d8800c1e22782a3d38d23
c2d317fc869d879b289e7d57ddecf34d1b79c63144775f6c5384b4b35c75f57202a2ca2e899
90f19cb6292a07cb0db56f9c29eb2516573fb639123ca0206fd50bec1d839b2cfd0ad5f1ed3
95d7c93850650b113d147167d74c4325de54d4b5d6335da56ab00dc8afd00dd7f591ae51847
81303e5a7af1da53acf5ecda32845be588fb973607a592092f4f936a01ba25c9d45b6373c73
8d7091fffbd6b3e925ebb113a7f33d03af505c78e3014fe28c5ebd8a902da2ae1269ee64c1e
b15604cb88599bac530a8c919dc7697b118f5c31831ebba412a98d59fddca63e9b50c45d460
fe8746d40f85805876849a0563aba40142609c3db3364f4cbd398941a86db215c049e7e09fe
38a9ac27965b04b59d5de9ae56fb998031d3677ec00eeedf90358e80738</proof>
  </secProgram>
</requestConfimation>
```

The following exemplary code listing a financial instrument in FIXML with encrypted values and terms and secure computations programs in accordance to the present disclosure. The code listing shows an exemplary encryption of some of the terms of a transaction order: specifically, the quantity of shares has been encrypted. There is also a secure computation program for a trading strategy in the form of a simple garbled circuit. The method of encryption used could be any of, but not restricted to: authenticated symmetric encryption; public key encryption; homomorphic encryption; shares of secret sharing scheme; garbled circuits; ORAMs; cryptographically-secure obfuscation; Proof-Certified Secure Programs and Circuits; and combinations thereof.

```
<?xml version=“1.0” encoding=“ASCII”?>
<FIXML>
  <Order ClOrdID=“789”
        Side=“2”
        TransactTm=“2015-09-09T05:00:00-01:00”
        OrdTyp=“2”
        Px=“27.43”
        Acct=“326827372”>
    <Hdr Snt=“2015-09-09T05:00:00-01:00”
        PosDup=“N”
        PosRsnd=“N”
        SeqNum=“234”>
      <Sndr ID=“HEDGEFUND”/>
      <Tgt ID=“ABROKER”/>
    </Hdr>
    <Instrmt Sym=“IBM”
          ID=“3243268423”
          IDSrc=“1”/>
    <OrdQty
Qty=“0e2c5e3fd5fdb01186d5a63ae5963faf27c0d0eb02a45be49fbaeb8d12”/>
  <secProgram>
<type>SimpleGarbledCircuit</type>
<description>Trading strategy</description>
<program>ee512d5fb1d19ae732263346661566bfc3b8b0f06424ee95fbadc53d59e86049b9
of7daeb445146c1e7afc7f092953ca14ccb197b71ce584f7dc62a9069daaddd9987202e18d3
1cfc0c3602d99e5c854312e15211671dd8cf6dfd6da2bebd2428f36d8b3ddb4471c7598f306
0a379a1aa2a10072bd5c23cbfae9a8abc46676bb24273efc3db9c828087b673ddbc785da324
17c51d61db6a53ee3342891fccef8e6853cee0756de17d8da2e78857986bdf6f2b5a71ac8e0
8f6a33b06dc8e42833a0ebb41b5fd65328fe4ab882a332ee85f9268a9d284ccaf4a9d7707fb
6d6a83be651d1252ff8effffc9d9d07956e884a57a64db533bbf0ae5119e1ab04543d4535d6
d5888cb5f45308f129f717ca23f6b52f57f715f4c8444758ea0937c0ecfb42fb655d88a3c1f
a45980bc0c18aa1879e666baea9c2295c158d85473ff2e818a732cd3e2401d622b9341cf9ce
e0481a152b65dbfed2cec1f8f5315e9cf7ca6e8c1edddc4aa11ef4</program>
<proof>e6a2c607b85bd96cabobb3d815c341ac52345cd268d82c970fc5919c1d6abf367ca3
60bc0696e47bee4f61b6e16a6268f192725982d5a60ffe9eb486fccedf0f206d083ff16969e
22c802f9756ac8b685fb8216e239098307a2ac0681f8ee011d48006833b975b828d33865b77
b420b169e41b0e2d1163b80d5ded1aacda4563a8b9b611aa95e3a2d24ecf93a8f87e9011328
24f2953c398b7ad1b1b05b30223bf945956bdcbfb2cb1a7be3eb03704c9e39392dd0271ffee
fca4c5fbbe4c9df6fab1991bd08e903e832a635a219bef0087ec635d6aa68560ffa39951f1c
899ab2e13b69dcdc82351ea444e63f0b476f0b32a339ec4ebcedd1489f45c704049738f2990
1fa3e51c4313a4cd5b49e47f01107b45ab47f4cc8438d7924d9222f7ef6ab0b8662b4244be9
060600a008957b7f874c0dd0de87cd08846a2fe2e66fc070a1118c0545b8f581728fb725810
5d48ff2ed381273347b7341569131dca504801a8859e702b9ddb1975e55cfff3b1488601187
a94b767ff6a68c082a8609e7023c7adaf5088a8ec9fc9ca6b8501d6caba709ebeab847c15b2
656e2a85a0c727600600a9c254717a26ba6f19871d6af450df09545df24bf727a428edd7a1e
1a2a796807f431055e025945d5db214b0df4e155fae6273add6cf252b5</proof>
  </secProgram>
  </Order>
</FIXML>
```

FIG. 5 illustrates is a non-limiting exemplary computer system 900 that executes secure computations on financial instruments in accordance to the present disclosure. It illustrates an exemplary computer system 900 as further discussed herein and in accordance with the present disclosure. The system is described herein only in so far as is necessary for an understanding of the present disclosure. The system 900 can be used for the operations described in association with the detailed descriptions, implementations and examples described herein. For example, the system 900 may be included in any or all of the server components 901, 902 and 903 discussed herein; these components incorporate a Central Processing Unit 904, a memory 905, a network device 906, a storage device 907 and a display 908: each of the components 904, 905, 906, 907 and 908 are interconnected using a system bus 909.

The Central Processing Unit 904 executes instructions within the server components 901, 902 and 903 discussed herein. In one implementation, the Central Processing Unit 904 is a single-core and single-threaded Central Processing Unit. In another implementation, the Central Processing Unit 904 is a multi-core and multi-threaded Central Processing Unit. The Central Processing Unit 904 executes instructions stored in the memory 905 or in the storage device 907, processing data in the memory 905 or in the storage device 907, data which may be transmitted over a network device 906 or which may be displayed graphically in a user interface on a display 908.

The memory 905 serves as an information store for system 900. In one implementation, the memory 905 is a computer-readable medium. In another implementation, the memory 905 is a volatile memory unit. In another implementation, the memory 905 is a non-volatile memory unit.

The network device 906 is capable of transmitting information to and from other computer systems 900 or any other computer systems. In one implementation, the network device 906 transmits information over fiber optic cables. In another implementation, the network device 906 transmits information over copper cables. In another implementation, the network device 906 transmits information over microwaves. In any or all of the previous implementations, the network device 906 may directly access the memory 905 and the Central Processing Unit 904 may directly access the network device 906.

The storage device 907 is capable of storing big amounts of data for the system 900. In one implementation, the storage device 907 is a computer-readable medium. In various different implementations, the storage device 907 may be a hard disk device, a floppy disk device, an optical disk device, a tape device, a Network-Attached Storage device, a Storage-Area Network device or a Cloud Storage device.

The display device 908 is capable of displaying processed data in a user interface. In one implementation, the display device 908 is a cathode ray tube monitor. In another implementation, the display device 908 is a liquid crystal display monitor. In another implementation, the display device 908 is a thin-film transistor monitor. In another implementation, the display device 908 is made from organic light-emitting diodes.

The algorithms, methods and systems can be implemented in digital electronic circuitry, or in computer hardware, firmware, software, or in a combinations of them. The algorithms and methods and systems, can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described algorithms, methods and systems can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (Application-Specific Integrated Circuits) or FPGAs (Field-Programmable Gate Arrays) or GPUs (Graphics Processing Units).

To provide for interaction with a user, the features can be implemented on a computer having a display device such as CRT (Cathode Ray Tube) or LCD (Liquid Crystal Device) or FT (Thin-Film Transistor) or OLED (Organic Light-Emitting Diode) monitor for displaying information to the user and a keyboard and a pointing device such as a mouse or a trackball by which the user can provide input to the computer.

The algorithms, methods and systems can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a RDMA-enabled connection, a WAN, and the computers and the networks forming the Internet. Those skilled in the art will appreciate that computer systems have a variety of configurations and protocols that can be used to communicate data, and thus, no particular configuration or protocol is considered limiting.

The computer system can include clients and servers. A client and server are generally remote from each other and typically interact through a network. The relationship of client and server arise by virtue of computer programs running on the respective computers and having a client-server relationship to each other.

In some examples, said previously described non-limiting exemplary computer system 900 implements all the algorithms, methods and systems described herein, the load and use of secure financial instruments from a spreadsheet enabled for secure computation as previously described in [FIG. 4] and automated theorem proving procedures described subsequently. Descriptions of additional claimed embodiments follow.

All the programs and circuits using the cited encryption schemes in the present disclosure (Yao's garbled circuits, GMW, reusable garbled circuits, secret sharing, homomorphic encryption, ORAM and/or cryptographically-secure obfuscation) could be accompanied with proofs. Said proofs on secure programs and circuits achieve one or more of the following goals: conformance of the circuits to an agreed specification, providing assurance that the circuit will really calculate what is supposed to calculate; correct termination of the circuit/program; and/or guarantees that some mathematical pre-conditions and post-conditions on the inputs and outputs will be satisfied; among other uses of said proofs. And although the use of automated theorem proving in cryptography is not new (eg. verification of the implementation of cryptographic implementations), the attachment of proofs to secure computation programs and circuits as claimed in the present disclosure and circuits is novel. These proofs would be of particular utility to users of financial instruments, especially when their secure programs and circuits appear in encrypted forms, since they would enable new scenarios such as their secure execution on remote computers without neither of the involved parties having any previous relationship: that is, conventional human trust between the parties is removed and replaced by mathematical assurances on the procedures to be carried out on the financial instrument, besides the previously mentioned enhanced security properties that the use of secure computation protocols provide regarding the privacy of the data used during the computations.

Details about automated theorem proving can be found in the papers cited herein and in the following books [Tobias Nipkow, Lawrence C. Paulson, Markus Wenzel. “Isabelle/HOL: A Proof Assistant for Higher-Order Logic”. Springer, 2002. ISBN 978-3-540-433767; Yves Bertot, Pierre Casterán. “Interactive Theorem Proving and Program Development”. Springer, 204. ISBN 978-3-540-20854-9]. Further details on the application of automated theorem proving to secure computation follows:
Proof-Certified Circuits: each circuit within a cryptographically secure financial instrument could be accompanied with one or more mathematical proofs generated with the help of automated theorem provers. The description of the circuits could be provided in multiple forms, exemplarily: gate level descriptions; Register-Transfer Level descriptions; descriptions in Hardware Description Language, such as Verilog circuits; and combinational circuits, or sequential ones so that no unrolling is necessary and smaller circuits and proofs are generated; the more expressive the descriptions of the circuits, the more powerful, sophisticated and shorter the proofs about them could be. Furthermore, and without loss of generality, the circuits could be Boolean (as those used with Yao's Garbled Circuit) or arithmetic (as those used with secret sharing schemes). Also, the proofs could be digitally-signed, to provide authenticity and non-repudiation of said proofs and circuits. The description of the procedure to generate said proofs is described below, in [FIG. 6].
Proof-Certified Secure Programs. Some secure computation programs could also exist in higher level languages than circuits: for example, ORAMs could be programmed in a Typed Assembly Language. For said higher-level programs, annotations tracing the information flow from inputs to outputs are generated when the code is compiled; then, the procedure continues with the generation of logical preconditions implying that any possible execution of the binary is safe according to a set of axioms and rules, if true; afterwards, an automated theorem prover uses said axioms, rules and preconditions to generate the proofs for the secure programs. Said proofs can be checked much faster and simpler when loading the secure computation program.
Proof-Certified Reusable Garbled Circuits: One limitation of garbled circuits is that they cannot be reused: that is, a garbling of a circuit can only be used one time for a given input, since multiple evaluations would compromise the privacy properties of said garbled circuit. However, combining garbling schemes with functional encryption, it's possible to obtain garbled circuit that runs on an arbitrary number of encoded inputs [Shafi Goldwasser, Yael Tauman Kalai, Raluca A. Popa, Vinod Vaikuntanathan, and Nickolai Zeldovich. “Reusable garbled circuits and succinct functional encryption” STOC 2013, pages 555-564]. A Proof-Certified Reusable Garbling scheme PCRG=(PCRG.Garble, PCRG.Enc, PCRG.Eval), allowing to check whether the garbled circuit follows a specification as described by a given proof, as defined herein: let E=(E.KeyGen, E.Enc, E.Dec) be a semantically secure symmetric-key encryption scheme and FE=(FE.Setup, FE.KeyGen, FE.Enc, FE.Dec) be a succinct fully secure functional encryption scheme for any class of circuits.
PCRG.Enc (gsk, x): Compute cₓ↓FE.Enc(fmpk, (sk, x)) and output cₓ.
PCRG.Eval (Γ, P, cₓ): Compute and output FE.Dec(Γ, P, cₓ).
PCRG.Garble (1^{k}, C):
   i. Generate FE keys (fmpk, fmsk)↓FE.Setup(1^{k}) and a secret key sk↓E. KeyGen(1^{k}).
   ii. Let E=E.Enc(sk, C)
   iii. Define U_{E} to be the following universal circuit (U_{E} takes as input a secret key sk, a value x and proof P about circuit C):
      1. Compute C=E.Dec (sk, E).
      2. If there is any digital signature accompanying the circuit C, check it: if it's not valid, stop the execution of the universal circuit.
      3. Check that C conforms to proof P: if not, stop the execution of the universal circuit.
      4. Run C on x.
   iv. Let Γ↓FE.KeyGen(fmsk, U_{E}) be the reusable garbled circuit. Said garbling Γ of circuit C, when included within the financial instrument, would constitute an example of an encrypted proof-certified secure computation program.
   v. Output gsk:=(fmpk, sk) as secret key and Γ as the garbling of C.

As shown on [FIG. 6], the user provides a structural description of the circuit [1001] describing the connections of the components of the circuit, and the circuit's behavioural description [1002]. Both descriptions are automatically translated to the language of the Interactive Theorem Prover (IPV), since constructing proof-checkers in native circuits/HDLs would be very complicated: the structural description of the circuit [1001] is translated as the implementation [1020] and the circuit's behavioural description [1002] is translated as the specification [1030]. A library of formally verified generic circuits [1010] contains the formal verification of the components that the structural description of the circuit [1001] can use: the basic logic gates AND, NAND, OR, NOR, NOT, XOR, XNOR [1011], MUX [1012], carrying the output signal from one of then input bits according to the select lines, and its inverse DEMUX [1012]; ENCODER [1013] with 2^{N} inputs and N outputs, outputting the physical address of the wire as selected from the input wire, and DECODER [1013] with N inputs and 2^{N} outputs, outputting a 1 on only the selected wire as chosen from N input bits; COMPARATORs [1014], for testing identity and also magnitude; ADDER and SUBSTRACTOR [1015] with two n-bit input vectors, an output vector and a carry bit vector; MULTIPLY [1016] with two n-bit input vectors and an output vector, built with ADDERs [1015]; among other components of circuits. The main benefit of this library of formally verified generic circuits is that the verification of most circuits built with its component is almost automatic, only requiring user input to guide the demonstration of the proof on very specific cases which the IPV can't handle. Therefore, theorems [1040] denoting that the circuits imply the specification are generated from the combination of [1010], [1020] and [1030], which are passed to the IPV [1050] for their automatic verification. When successful, two outputs are generated: a formal proof that the given circuit satisfies the specification [1060], which can be checked with far less computational resources that the resources used for its generation, and which would be digitally signed; and the formally verified circuit code [1070], now fully synthesized in contrast to the structural description of the circuit [1001].

The following algorithm illustrates some elements of claims 4, 5, 9, 10, 14 and 15.

Algorithm 4. Generation of Proofs for Proof-Certified Secure Computation Programs.

1.
a. Given the structural description of the circuit, translate it as the implementation. That is, for every component of the circuit:
   i. Search said component on the IPV's library of formally verified components and circuits.
   ii. Instantiate said component, now with the language of the IPV.
   iii. Interconnect the wires of the component with the other components, until all the structural description of the circuit has been translated.
b. Given the circuit's behavioural description, translate it as the specification:
   i. Parse the source code of the circuit's behavioural description and obtain its Abstract Syntax Tree (AST).
   ii. Cover the AST, emitting source code in the language of the IPV using a table of translations.
c. Given the implementation, specification and the library of formally verified circuits, generate formal proofs and the formally verified circuit code:
   i. Generate theorems by combining said inputs and using a library of rules, axioms and preconditions.
   ii. Verify the generated theorems:
      1. If the Automated Theorem Prover is unable to automatically obtain formal proofs, a situation that rarely happens: provide user input guiding the Automated Theorem Prover.
      2. Obtain the formal proofs implying that the circuit satisfies the specification from the Automated Theorem Prover: said proofs are computationally easy to check, but computationally difficult to generate.
      3. Digitally sign said formal proofs.
   iii. Obtain the fully synthesized and formally verified circuit code.

The following algorithm illustrates claims 4, 9 and 14.

Algorithm 5. Secure Computation of Proof-Certified Secure Computation Programs on Financial Instruments.

1.
a. The secure processing module obtains one or more financial instruments:
   i. Said secure processing module listens for incoming connections that contain financial instruments.
   ii. Said secure processing module watches for changes on the filesystem, and reads files whenever there is a change.
b. Secure computation programs are initialized by the secure cryptographic module:
   i. Secure computation programs could exist within financial instruments, or completely standalone on the filesystem.
   ii. Memory is allocated and reserved.
c. Financial instruments are parsed and checked for correctness by the secure processing module:
   i. Syntactic validation is executed.
   ii. Semantic validation is executed.
   iii. Numeric values are checked against ranges of market data to detect inconsistencies and outliers.
   iv. Cryptographic signatures are checked, and the general correctness of the encrypted data.
   v. In case of error on any of the previous steps, the procedure stops.
d. Financial instruments are received by the secure cryptographic module from the secure processing module.
e. Encrypted terms and/or values are decrypted by the secure processing module (note that some financial instrument may not have any encrypted term and/or values, nor contain secure computation programs; that is, it's possible to carry out secure computation on conventional financial instruments by using secure computation programs stored on the filesystem):
   i. Keys to decrypt the encrypted values are retrieved.
   ii. The decryption process is executed: note that the encrypted data of some encryption methods do not have to be decrypted (eg. homomorphic encryption and the encrypted shares of a secret sharing scheme).
f. External data is retrieved from markets, as required by secure computation programs:
   i. Exemplarily, current public values of indices, shares, bonds, options, futures and other financial instruments are obtained.
   ii. Exemplarily, the secret encrypted values of other financial instruments could be retrieved and used in the secure computation of the present financial instrument.
g. Secure computation programs are executed by the secure cryptographic module, that is, for every secure computation program:
   i. Get the type of secure computation program, as any of the described within the present disclosure, but not strictly limited to them: Yao's garbled circuits and oblivious transfers, GMW circuits, secret sharing, homomorphic encryption, ORAMs, or combinations thereof; garbled circuits and oblivious transfer being the preferred one.
   ii. Check digital signatures of secure computation programs: if found wrong, stop the execution.
   iii. Check digital signatures of the proofs: if found wrong, stop the execution.
   iv. Validate that said secure computation programs are well-founded according to their proofs: if found wrong, stop the execution.
   v. Execute said secure computation programs:
      1. Given the secure computation program, the financial instrument management system executes it using the adequate library from the libraries for secure computation of the financial instrument management system: said library could be proprietary or open-source, in case more security through transparency and peer-examination of the critical source code is desired.
      2. The secure computation program may need access to external data sources, encrypted or not, during its execution: by default is granted, unless a policy explicitly denies it.
      3. At least a value is determined from said secure computation.
h. Data resulting from the secure computation is sent to the markets by the secure cryptographic module:
   i. Exemplarily, orders to take exposure in any financial instrument, independently of its readiness for secure computation.
i. Terms and/or values of the financial instrument are encrypted back by the secure cryptographic module:
   i. Keys to encrypt the encrypted values are retrieved.
   ii. The encryption process is executed: some encryption methods require the information to be encrypted back, such as authenticated symmetric encryption and public key encryption.
j. Financial instruments are received by the secure processing module from the secure cryptographic module.
k. The secure processing module sends to the network the resulting one or more financial instruments, or stores them locally on the filesystem.
l. Alternatively, they could be deleted if they are deemed as not needed anymore.

The following algorithms illustrates claims 5, 10 and 15.

Algorithm 6. Secure Computation of Proof-Certified Encrypted Secure Computation Programs on Financial Instruments.

1.
a. The secure processing module obtains one or more financial instruments:
   i. Said secure processing module listens for incoming connections that contain financial instruments.
   ii. Said secure processing module watches for changes on the filesystem, and reads files whenever there is a change.
b. Secure computation programs are initialized by the secure cryptographic module:
   i. Secure computation programs could exist within financial instruments, or completely standalone on the filesystem.
   ii. Memory is allocated and reserved.
c. Financial instruments are parsed and checked for correctness by the secure processing module:
   i. Syntactic validation is executed.
   ii. Semantic validation is executed.
   iii. Numeric values are checked against ranges of market data to detect inconsistencies and outliers.
   iv. Cryptographic signatures are checked, and the general correctness of the encrypted data.
   v. In case of error on any of the previous steps, the procedure stops.
d. Financial instruments are received by the secure cryptographic module from the secure processing module.
e. Encrypted terms and/or values are decrypted by the secure processing module (note that some financial instrument may not have any encrypted term and/or values, nor contain secure computation programs; that is, it's possible to carry out secure computation on conventional financial instruments by using secure computation programs stored on the filesystem):
   i. Keys to decrypt the encrypted values are retrieved.
   ii. The decryption process is executed: note that the encrypted data of some encryption methods do not have to be decrypted (eg. homomorphic encryption and the encrypted shares of a secret sharing scheme).
f. External data is retrieved from markets, as required by secure computation programs:
   i. Exemplarily, current public values of indices, shares, bonds, options, futures and other financial instruments are obtained.
   ii. Exemplarily, the secret encrypted values of other financial instruments could be retrieved and used in the secure computation of the present financial instrument.
g. Secure computation programs are executed by the secure cryptographic module, that is, for every secure computation program:
   i. Get the type of secure computation program, as any of the described within the present disclosure, but not strictly limited to them: reusable garbled circuits, circuits over secret sharing schemes, circuits over homomorphic encryption schemes, cryptographically-secure obfuscation, and combinations thereof; reusable garbled circuits being the preferred one.
   ii. Check digital signatures of secure computation programs: if found wrong, stop the execution.
   iii. Check digital signatures of the proofs: if found wrong, stop the execution.
   iv. Execute said secure computation programs:
      1. Given the secure computation program, the financial instrument management system executes it using the adequate library from the libraries for secure computation of the financial instrument management system: said library could be proprietary or open-source, in case more security through transparency and peer-examination of the critical source code is desired.
      2. Validate during their execution that said secure computation programs are sound and well-founded according to their proofs: if found wrong, stop the execution.
      3. The secure computation program may need access to external data sources, encrypted or not, during its execution: by default is granted, unless a policy explicitly denies it.
      4. At least a value is determined from said secure computation.
h. Data resulting from the secure computation is sent to the markets by the secure cryptographic module:
   i. Exemplarily, orders to take exposure in any financial instrument, independently of its readiness for secure computation.
i. Terms and/or values of the financial instrument are encrypted back by the secure cryptographic module:
   i. Keys to encrypt the encrypted values are retrieved.
   ii. The encryption process is executed: some encryption methods require the information to be encrypted back, such as authenticated symmetric encryption and public key encryption.
j. Financial instruments are received by the secure processing module from the secure cryptographic module.
k. The secure processing module sends to the network the resulting one or more financial instruments, or stores them locally on the filesystem:
   i. Alternatively, they could be deleted if they are deemed as not needed anymore.

The logic flows depicted in the figures do not require the particular order shown, or sequential order, to achieve the desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Although the subject matter has been described in language specific to the structural features and/or methodological acts, it is to be understood that the subject matter defined in the appended claims is not necessarily limited to the specific features or acts described above, and that various modifications may be made without departing from the spirit and scope of the present disclosure. Rather, the specific features or acts described above are disclosed as example forms of implementing the claims, and other implementations are within the scope of the following claims.

I have therefore described an implementation of a financial instrument management system enhanced with secure computation that uses the latest cryptographic techniques to ultimately lower financial risks, improve yields, create new financial instruments and provide new ways to package them and, in general, improve the performance of markets and the price mechanism.

1. An exchange-independent financial instrument having at least a value determined by the result of at least a secure computation program executed on at least one computer device.

2. The exchange-independent financial instrument of claim 1, wherein said exchange-independent financial instrument is converted from an exchange-independent financial instrument with no value determined by the result of at least a secure computation program executed on at least one computer device to an exchange-independent financial instrument with at least one encrypted term and/or value.

3. The exchange-independent financial instrument of claim 1, wherein said exchange-independent financial instrument is aggregated from exchange-independent financial instruments with no value determined by the result of at least a secure computation program executed on at least one computer device; and/or exchange-independent financial instruments with at least one encrypted term and/or value.

4. The exchange-independent financial instrument of claim 1, wherein said exchange-independent financial instrument contains a proof-certified secure computation program.

5. The exchange-independent financial instrument of claim 1, wherein said exchange-independent financial instrument contains an encrypted proof-certified secure computation program.

6. A computer implemented method for securely computing one or more exchange-independent financial instruments, the method comprising at least one or more of: encrypting and/or decrypting terms and/or values of said exchange-independent financial instruments; and executing one or more secure computation programs on said exchange-independent financial instruments using at least one privacy-preserving protocol from a group of privacy-preserving protocols consisting of: garbled circuits and oblivious transfers, GMW circuits, secret sharing, homomorphic encryption, oblivious random access machines (ORAMs), and combinations thereof.

7. The computer implemented method for securely computing one or more exchange-independent financial instruments of claim 6, further comprising at least one or more of: rewriting fields, terms and/or values of exchange-independent financial instruments; and generating secure computation programs; and customising existing secure computation programs; and signing secure computation programs; and including secure computation programs within said exchange-independent financial instruments.

8. The computer implemented method for securely computing one or more exchange-independent financial instruments of claim 6, further comprising at least one or more of: creating an aggregate exchange-independent financial instrument; and generating secure computation programs; and customising existing secure computation programs; and signing secure computation programs; and including secure computation programs within said exchange-independent financial instruments.

9. The computer implemented method for securely computing one or more exchange-independent financial instruments of claim 6, further comprising at least one or more of: obtaining existing proofs of secure computation programs; and generating proofs of secure computation programs; and including proofs of secure computation programs within said exchange-independent financial instruments; and validating proofs of secure computation programs; and generating proof-certified secure computation programs; and customising existing proof-certified secure computation programs; and signing proof-certified secure computation programs; and including proof-certified secure computation programs within said exchange-independent financial instruments.

10. The computer implemented method for securely computing one or more exchange-independent financial instruments of claim 6, further comprising at least one or more of: obtaining existing proofs of encrypted secure computation programs; and generating proofs of encrypted secure computation programs; and including proofs of encrypted secure computation programs within said exchange-independent financial instruments; and validating proofs of encrypted secure computation programs; and using privacy-preserving protocols for encrypted secure computation programs: reusable garbled circuits, circuits over secret sharing schemes, circuits over homomorphic encryption schemes, cryptographically-secure obfuscation, and combinations thereof; and generating encrypted proof-certified secure computation programs; and customising existing encrypted proof-certified secure computation programs; and signing encrypted proof-certified secure computation programs; and including encrypted proof-certified secure computation programs within said exchange-independent financial instruments.

11. A financial instrument management system executed on at least one computer device, comprising: a secure processing module configured to obtain one or more exchange-independent financial instruments, and to check the correctness of said obtained exchange-independent financial instruments, and to keep the exchange-independent financial instruments resulting from the secure cryptographic module; and a secure cryptographic module configured to receive said exchange-independent financial instruments from said secure processing module, and to encrypt and/or decrypt terms and/or values of said exchange-independent financial instruments, and to execute one or more secure computation programs on said exchange-independent financial instruments using at least one privacy-preserving protocol from a group of privacy-preserving protocols consisting of: garbled circuits and oblivious transfers, GMW circuits, secret sharing, homomorphic encryption, oblivious random access machines (ORAMs), and combinations thereof.

12. The financial instrument management system of claim 11, wherein said secure processing module is additionally configured to rewrite fields, terms and/or values of exchange-independent financial instruments, and wherein the secure cryptographic module is additionally configured to at least one or more of: generate secure computation programs; and customise existing secure computation programs; and sign secure computation programs; and include secure computation programs within said exchange-independent financial instruments.

13. The financial instrument management system of claim 11, wherein the secure processing module is additionally configured to create an aggregate exchange-independent financial instrument and wherein the secure cryptographic module is additionally configured to at least one or more of: generate secure computation programs; and customise existing secure computation programs; and sign secure computation programs; and include secure computation programs within said exchange-independent financial instruments.

14. The financial instrument management system of claim 11, wherein the secure cryptographic module is additionally configured to at least one or more of: obtain existing proofs of secure computation programs; and generate proofs of secure computation programs; and include proofs of secure computation programs within said exchange-independent financial instruments; and validate proofs of secure computation programs; and generate proof-certified secure computation programs; and customise existing proof-certified secure computation programs; and sign proof-certified secure computation programs; and include proof-certified secure computation programs within said exchange-independent financial instruments.

15. The financial instrument management system of claim 11, wherein the secure cryptographic module is additionally configured to at least one or more of: obtain existing proofs of encrypted secure computation programs; and generate proofs of encrypted secure computation programs; and include proofs of encrypted secure computation programs within said exchange-independent financial instruments; and validate proofs of encrypted secure computation programs; and use privacy-preserving protocols for encrypted secure computation programs: reusable garbled circuits, circuits over secret sharing schemes, circuits over homomorphic encryption schemes, cryptographically-secure obfuscation, and combinations thereof; and generate encrypted proof-certified secure computation programs; and customise existing encrypted proof-certified secure computation programs; and sign encrypted proof-certified secure computation programs; and include encrypted proof-certified secure computation programs within said exchange-independent financial instruments.
